(19) United States
(12) Patent Application Publication
(10) Pub. No.: US 2018/0257552 A1
(43) Pub. Date: Sep. 13, 2018

(54) VEHICLE COMPRISING TURN SIGNAL LIGHTS, AND METHOD FOR SIGNALING A DRIVING DIRECTION TO FOLLOWING VEHICLES

(71) Applicant: HELLA GmbH & Co. KGaA, Lippstadt (DE)

(72) Inventor: Matthias HELLGE, Passau (DE)

(73) Assignee: HELLA GmbH & Co. KGaA, Lippstadt (DE)

(21) Appl. No.: 15/978,927

(22) Filed: May 14, 2018

Related U.S. Application Data
(63) Continuation of application No. PCT/EP2016/077331, filed on Nov. 10, 2016.

(30) Foreign Application Priority Data
Nov. 12, 2015 (DE) 10 2015 119 549.6

(51) Int. Cl. B60Q 1/52; B60Q 1/46

(52) U.S. Cl. CPC B60Q 1/52; B60Q 1/38; B60Q 1/46

(57) ABSTRACT

A vehicle comprising two intermittent turn signal lights located at the rear of the vehicle, characterized in that in order to signal a driving direction to following traffic to drive around the vehicle, an optical sweeping effect created by the first turn signal light and an optical sweeping effect created by the second turn signal light point in the same sweeping direction.

This nonprovisional application is a continuation of International Application No. PCT/EP2016/077331, which was filed on Nov. 10, 2016, and which claims priority to German Patent Application No. DE 10 2015 119 549.6, which was filed in Germany on Nov. 12, 2015, and which are both herein incorporated by reference.

### BACKGROUND OF THE INVENTION

### Field of the Invention

The present invention relates to a vehicle with two intermittent turn signal lights located at a rear of the vehicle. Further, the invention relates to a method for signaling a driving direction to following traffic to drive around a vehicle by means of the turn signal lights located at the rear of the vehicle.

### Description of the Background Art

Light is a medium that can touch different emotions and sensations depending on the application, use, and staging or that is used for technical processes.

The use of direction indicators, as well as flashing lights or turn signal lights, has been known for a long time from the prior art. A flashing light is a light source that can periodically change its brightness by means of a technical device. Intermittent turn signal lights are also known from the prior art. In various vehicle manufacturers, the function of the sweeping-type flashing for different flash modes is used to enhance the flashing effect. In this case, the sweeping direction is predetermined and is used exclusively as a turning function when turning or changing lanes and as a warning function in the event of danger.

An optical sweeping effect can be generated by means of an intermittent turn signal light. In this case, sweeping of the light in the turn signal light takes place from left to right or from right to left, depending on the direction of the turn.

If the turn signal lights are used as hazard warning lights as part of a warning function, the light in the two flashing lights sweeps away from one another. In other words, in the case of the left turn signal light, the sweeping effect goes from right to left and in the case of the right turn signal light from left to right.

A disadvantage of the prior art is that only a warning function for the following traffic is possible with the turn signal lights in addition to their turning function.

### SUMMARY OF THE INVENTION

The object of the present invention is to overcome the disadvantages of the prior art and to additionally improve the safety for the following traffic.

To achieve this object, a vehicle is provided in an exemplary embodiment comprising two intermittent turn signal lights located at the rear of the vehicle, wherein in order to signal a driving direction to the following traffic to drive around the vehicle, an optical sweeping effect created by the first turn signal light and an optical sweeping effect created by the second turn signal light point in the same sweeping direction.

The object is further achieved by a method for signaling a driving direction to the following traffic to drive around a vehicle, by means of two intermittent turn signal lights located at the rear of a vehicle, the method comprising the step of signaling the driving direction, wherein an optical sweeping effect created by the first turn signal light and an optical sweeping effect created by the second turn signal light point in the same sweeping direction.

The particular advantage of the invention is that by providing the intermittent turn signal lights, in addition to a warning function, a signaling of the driving direction to the following traffic to drive around the vehicle (danger area) can be done in a simple manner. This can additionally improve the safety for the following traffic. Traffic jams can also be better prevented by providing the directional signaling.

For example, an intermittent turn signal light is a turn signal light that is set up to create an optical sweeping effect. When flashing, the individual LEDs preferably light up in succession, so that the optical sweeping effect arises. In this case, a sweeping of the light in the turn signal lights goes from left to right or from right to left.

The turn signal lights can be warning beacons. For example, the vehicle is a passenger vehicle, truck, or a motorized two- or three-wheeled vehicle.

The optical sweeping effect created by the first turn signal light and the optical sweeping effect created by the second turn signal light can occur synchronously in the same sweeping direction or offset in time in the same sweeping direction.

A directional signaling can be easily displayed by means of the synchronous sweeping effect. In this case, the light, emitted by the LEDs, of the left turn signal light and at the same time the light, emitted by the LEDs, of the right turn signal light run in the same direction.

The directional signaling can be shown even better by means of the sweeping effect that is offset in time. In this case, the light, emitted by the LEDs, of the left turn signal light and subsequently the light, emitted by the LEDs, of the right turn signal light run in the same direction. Preferably, the turn signal lights work on the principle of a warning beacon.

The turn signal lights can have a plurality of series-connected LEDs.

This makes it possible to create a perceptible sweeping effect in a simple manner. The LEDs create the sweeping effect by being activated and again deactivated in succession. As a result of the activation of the turn signal lights, the light emitted by the LEDs travels to the left or to the right. Preferably, the LEDs are formed as an LED strip or a light strip.

The time from the turning on of a first LED to a last LED is 0.1 to 2.0 seconds.

This can produce a sweeping effect perceptible by the human eye. Preferably, the activation of the first LED to the activation of the last LED takes 0.2 seconds.

The series-connected LEDs light up from a first side to a second side in the turn signal lights. As mentioned above, the light in the turn signal lights sweeps from left to right or from right to left.

The turn signal lights can be activated manually in the vehicle.

For example, the input occurs via a button, a switch, or a lever in the vehicle. Depending on where the vehicle is located, it is now up to the driver to activate the turn signal lights. If the vehicle comes to a halt on a two-lane road in the direction of travel in the left-hand lane, the two turn signal lights can be set to the right. If the vehicle comes to a halt on the two-lane road in the direction of travel in the right-hand lane, both turn signal lights can be set to the left.

The turn signal lights can be activated automatically by means of a sensor system.

Preferably, the sensor system of the vehicle is set up to control and activate the turn signal lights in a dangerous situation, e.g., as a result of an accident or breakdown.

The sensor system for determining the sweeping direction is set up to detect a lane other than the lane occupied by the vehicle.

This makes it possible to drive around the lane occupied by the vehicle. Sensors of the sensor system are preferably located on the left and right side of the vehicle.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a top plan view of a road with a vehicle and activated turn signal lights;

FIG. 2 is a further top plan view of a road with a vehicle and activated turn signal lights;

FIG. 3 is a top plan view of a road with a vehicle and activated turn signal lights of the invention; and

FIG. 4 is a further top plan view of a road with a vehicle and activated turn signal lights of the invention.

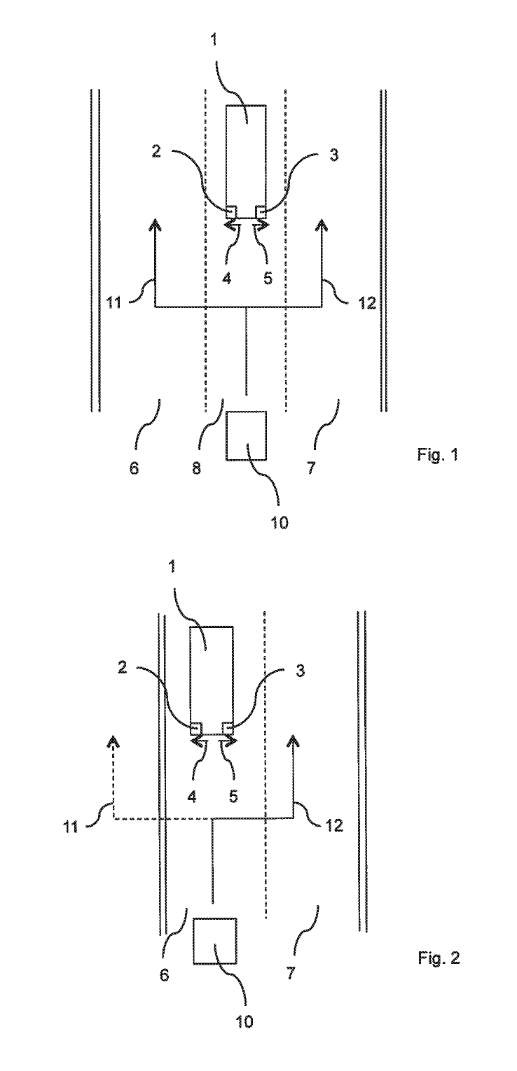

### DETAILED DESCRIPTION

The road has three lanes 6, 7, 8. Vehicle 1 has broken down in middle lane 8. Following traffic 10 approaches vehicle 1 in middle lane 8.

Vehicle 1 has a rear area. Two turn signal lights 2, 3 are located at the rear of vehicle 1. Turn signal lights 2, 3 are used to signal a driving direction to following traffic 10. Turn signal lights 2, 3 are designed as intermittent turn signal lights to create an optical sweeping effect. The sweeping effect created by both turn signal lights 2, 3 occurs simultaneously in directions 4, 5 moving away from one another.

The turn signal lights have a plurality of series-connected LEDs. The LEDs create the sweeping effect by being activated and again deactivated in succession. As a result of the activation of turn signal lights 2, 3, the emitted light in left turn signal light 2 travels to the left and in right turn signal light 3 to the right. In this way, the following traffic 10 is signaled that vehicle 1 is in a dangerous situation. Driving around the vehicle can occur according to arrows 11 and 12 via left lane 6 or right lane 7.

FIG. 2 shows a further top plan view of a road with a vehicle and activated turn signal lights.

The road has two lanes 6, 7. Vehicle 1 has broken down in left lane 6. Following traffic 10 approaches vehicle 1 in lane 6.

Vehicle 1 also has a rear area. Two turn signal lights 2, 3 are located at the rear of vehicle 1. Turn signal lights 2, 3 are used to signal a driving direction to following traffic 10. Turn signal lights 2, 3 are designed as intermittent turn signal lights to create an optical sweeping effect. The sweeping effect created by both turn signal lights 2, 3 occurs simultaneously or substantially simultaneously in directions 4, 5 moving away from one another.

The turn signal lights have a plurality of series-connected LEDs. The LEDs create the sweeping effect by being activated and again deactivated in succession. As a result of the activation of turn signal lights 2, the emitted light in left turn signal light 2 travels to the left and in right turn signal light 3 to the right. In this way, the following traffic 10 is signaled that vehicle 1 is in a dangerous situation. Driving around the vehicle can occur according to arrow 12 only via right lane 6.

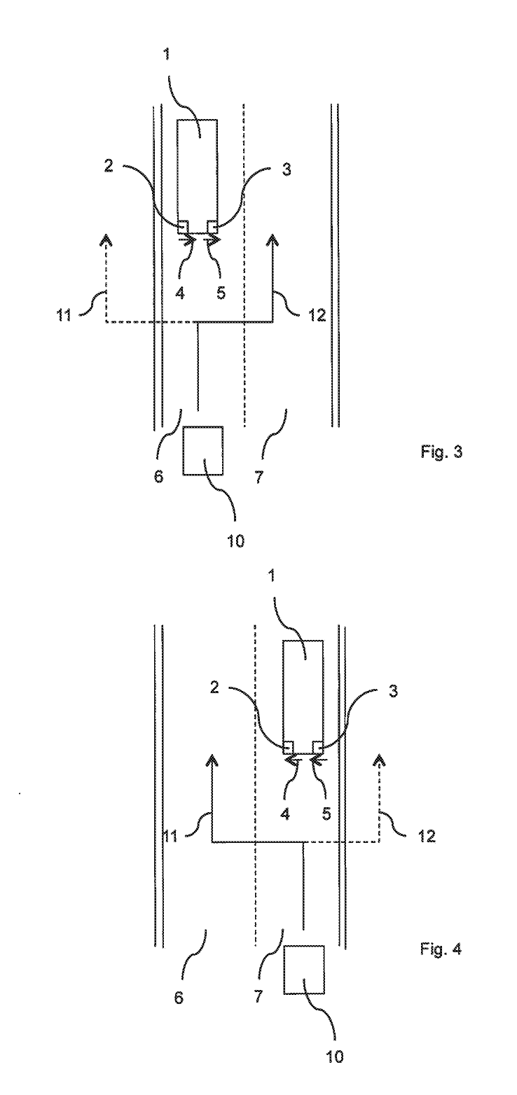

FIG. 3 shows a top plan view of a road with a vehicle and activated turn signal lights of the invention.

The road has two lanes 6, 7. Vehicle 1 has broken down in left lane 6. Following traffic 10 approaches vehicle 1 in lane 6.

Vehicle 1 has a rear area. Two turn signal lights 2, 3 are located at the rear of vehicle 1. Turn signal lights 2, 3 are used to signal a driving direction to following traffic 10. Turn signal lights 2, 3 are designed as intermittent turn signal lights to create an optical sweeping effect. The sweeping effect created by both turn signal lights 2, 3 occurs simultaneously or substantially simultaneously in the same direction 4, 5.

The turn signal lights have a plurality of series-connected LEDs. The LEDs create the sweeping effect by being activated and again deactivated in succession. As a result of the activation of turn signal lights 2, 3, the light emitted by the LEDs in both turn signal lights 2, 3 travels from left to right. In this way, the following traffic 10 is signaled that vehicle 1 is in lane 6 and that evasive action according to arrow 12 is only possible via right lane 7.

Alternatively, the sweeping effect can also be offset in time in the same sweeping direction. In this case, the light, emitted by the LEDs, of left turn signal light 2 runs from left to right and subsequently the light, emitted by the LEDs, of right turn signal light 3 also runs from left to right.

FIG. 4 shows a further top plan view of a road with a vehicle and activated turn signal lights of the invention.

The road has two lanes 6, 7. Vehicle 1 has broken down in right lane 7. Following traffic 10 approaches vehicle 1 in lane 7.

Vehicle 1 also has a rear area. Two turn signal lights 2, 3 are located at the rear of vehicle 1. Turn signal lights 2, 3 are used to signal a driving direction to following traffic 10. Turn signal lights 2, 3 are designed as intermittent turn signal lights to create an optical sweeping effect. The sweeping effect created by both turn signal lights 2, 3 occurs simultaneously in the same direction 4, 5.

The turn signal lights have a plurality of series-connected LEDs. The LEDs create the sweeping effect by being activated and again deactivated in succession. As a result of the activation of turn signal lights 2, 3, the light emitted by the LEDs in both turn signal lights 2, 3 travels from right to left. In this way, the following traffic 10 is signaled that vehicle 1 is in lane 7 and that evasive action according to arrow 11 is only possible via left lane 6.

Alternatively, the sweeping effect can also be offset in time in the same sweeping direction. In this case, the light, emitted by the LEDs, of left turn signal light 2 runs from right to left and subsequently the light, emitted by the LEDs, of right turn signal light 3 also runs from right to left.

As shown in FIGS. 3 and 4, by providing the intermittent turn signal lights, in addition to a warning function, a directional signaling as well to the following traffic to drive around the vehicle can be easily accomplished. Thus, the safety for the following traffic can be further improved, which may also prevent traffic jams.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A vehicle comprising: a first and second intermittent turn signal lights located at a rear of the vehicle, wherein, in order to signal a driving direction to following traffic to drive around the vehicle, an optical sweeping effect created by the first turn signal light and an optical sweeping effect created by the second turn signal light point in the same sweeping direction.

2. The vehicle according to claim 1, wherein the optical sweeping effect created by the first turn signal light and the optical sweeping effect created by the second turn signal light occur substantially synchronously in a same sweeping direction or offset in time in the same sweeping direction.

3. The vehicle according to claim 1, wherein the turn signal lights have a plurality of series-connected LEDs.

4. The vehicle according to claim 1, wherein a time from the turning on of a first LED to a last LED is 0.1 to 2.0 seconds.

5. The vehicle according to claim 1, wherein the series-connected LEDs light up from a first side to a second side in the turn signal light.

6. The vehicle according to claim 1, wherein the first and second turn signal lights are activated manually in the vehicle. The vehicle according to claim 1, wherein the first and second turn signal lights are activated automatically a sensor system.

8. The vehicle according to claim 7, wherein the sensor system for determining the sweeping direction is set up to detect a lane other than that occupied by the vehicle.

9. A method for signaling a direction to following traffic to drive around a vehicle, the method comprising:
providing fist and second intermittent turn signal lights arranged at a rear of a vehicle; and
signaling a driving direction, wherein an optical sweeping effect created by the first turn signal light and an optical sweeping effect created by the second turn signal light point in a same sweeping direction.
